(19) United States
(12) Patent Application Publication
(10) Pub. No.: US 2006/0206853 A1
(43) Pub. Date: Sep. 14, 2006

(54) Method of producing mask inspection data, method of manufacturing a photo mask and method of manufacturing a semiconductor device

(76) Inventors: Takashi Kamo, Yokohama-shi (JP); Osamu Ikenaga, Yokohama-shi (JP); Tomohiro Tsutsui, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/360,688

(22) Filed: Feb. 24, 2006

(30) Foreign Application Priority Data
Feb. 25, 2005 (JP) 2005-050992

(51) Int. Cl. G06F 17/50; G06K 9/00

(52) U.S. Cl. 716/19; 716/4; 716/21; 382/144

(57) ABSTRACT

There is disclosed a method of producing mask inspection data, including preparing design data of a semiconductor device preparing a lithography condition relevant to a lithography process for transferring a mask pattern formed on a photo mask onto a wafer, preparing a wafer processing condition relevant to wafer processing using a pattern transferred onto the wafer, preparing a first proximity correction model for correcting proximity effect relevant to the lithography condition and the wafer processing condition, generating mask pattern data based on the design data and the first proximity correction model, and generating mask inspection data corresponding to the mask pattern data.

### CROSS-REFERENCE TO RELATED APPLICATIONS

This application is based upon and claims the benefit of priority from prior Japanese Patent Application No. 2005-050992, filed Feb. 25, 2005, the entire contents of which are incorporated herein by reference.

### BACKGROUND OF THE INVENTION

1. Field of the Invention

The present invention relates to a method of producing mask inspection data, a method of manufacturing a photo mask and a method of manufacturing a semiconductor device.

2. Description of the Related Art

Recently, dimensional accuracy required for a photo mask has become rapidly strict. In order to make a correspondence between a circuit pattern shape formed on a wafer and a design pattern shape, a photo mask is produced using a method calling proximity correction. According to the proximity correction, wiring data is corrected.

The foregoing proximity correction is largely classified into the following two methods. That is, one is a method of making rule-based corrections, and another is a method of making model-based (simulation-based) corrections. According to the model-based corrections, corrections are made using a model lumping dimensional errors occurring in mask process, wafer lithography process and wafer etching process.

When inspection is made with respect to the manufactured photo mask, writing data pattern shape and inspection data pattern shape are the same except a bias value. However, no correspondence is given between mask processed dimension and mask target dimension. Moreover, the difference exists between mask pattern shape and inspection data pattern shape. For this reason, inspection noise is generated resulting from false defect. This is factor of causing a problem that defect detection sensitivity is not increased.

For example, JPN. PAT. APPLN. KOKAI Publication No. 2002-318448 is given as the prior art.

### BRIEF SUMMARY OF THE INVENTION

According to a first aspect of the present invention, there is provided a method of producing mask inspection data, comprising: preparing design data of a semiconductor device: preparing a lithography condition relevant to a lithography process for transferring a mask pattern formed on a photo mask onto a wafer; preparing a wafer processing condition relevant to wafer processing using a pattern transferred onto the wafer; preparing a first proximity correction model for correcting proximity effect relevant to the lithography condition and the wafer processing condition; generating mask pattern data based on the design data and the first proximity correction model; and generating mask inspection data corresponding to the mask pattern data.

According to a second aspect of the present invention, there is provided a method of manufacturing a photo mask, comprising: preparing mask pattern data and mask inspection data obtained by the method according to the first aspect; preparing a mask process condition for producing a photo mask; preparing a second proximity correction model for correcting proximity effect relevant to the mask process condition; generating mask writing data based on the mask pattern data and the second proximity correction model; producing a photo mask based on the mask writing data and the mask process condition; detecting a shape of a pattern formed on the produced photo mask to acquire mask detection information; and comparing the mask detection information with the mask inspection data to inspect the photo mask.

According to a third aspect of the present invention, there is provided a method of manufacturing a photo mask, comprising: preparing mask pattern data for manufacturing a photo mask having a pattern based on design data, the mask pattern data being based on the design data and a first proximity correction model for correcting proximity effect relevant to lithography condition and wafer processing condition, the lithography condition relating to a lithography process for transferring a mask pattern formed on a photo mask onto a wafer, the wafer processing condition relating to wafer processing using a pattern transferred onto the wafer; generating mask inspection data for inspecting a pattern to be formed on the photo mask based on the mask pattern data; preparing a mask process condition for producing the photo mask; preparing a second proximity correction model for correcting proximity effect relevant to the mask process condition; generating mask writing data based on the mask pattern data and the second proximity correction model; producing a photo mask based on the mask writing data and the mask process condition; detecting a shape of a pattern formed on the produced photo mask to acquire mask detection information; and comparing the mask detection information with the mask inspection data to inspect the photo mask.

### BRIEF DESCRIPTION OF THE SEVERAL VIEWS OF THE DRAWING

FIG. 1 is a flowchart to explain a method of producing mask inspection data, a method of manufacturing a photo mask and a method of manufacturing a semiconductor device according to an embodiment of the present invention;

FIG. 2 is a flowchart to explain the procedure of producing a mask having the same dimension by only mask process correction using two kinds of mask processes having different mask process conditions;

FIG. 3 is a top plan view showing mask pattern, writing data pattern and produced pattern according to an embodiment of the present invention;

FIG. 4 is a top plan view showing mask pattern, writing data pattern and produced pattern according to an embodiment of the present invention;

FIG. 5A and FIG. 5B are views each showing a mask process correction model according to an embodiment of the present invention; and

FIG. 6 is a table showing a relationship between mask producing condition, mask process correction model, inspection data and writing data.

### DETAILED DESCRIPTION OF THE INVENTION

An embodiment of the present invention will be described below with reference to the accompanying drawings.

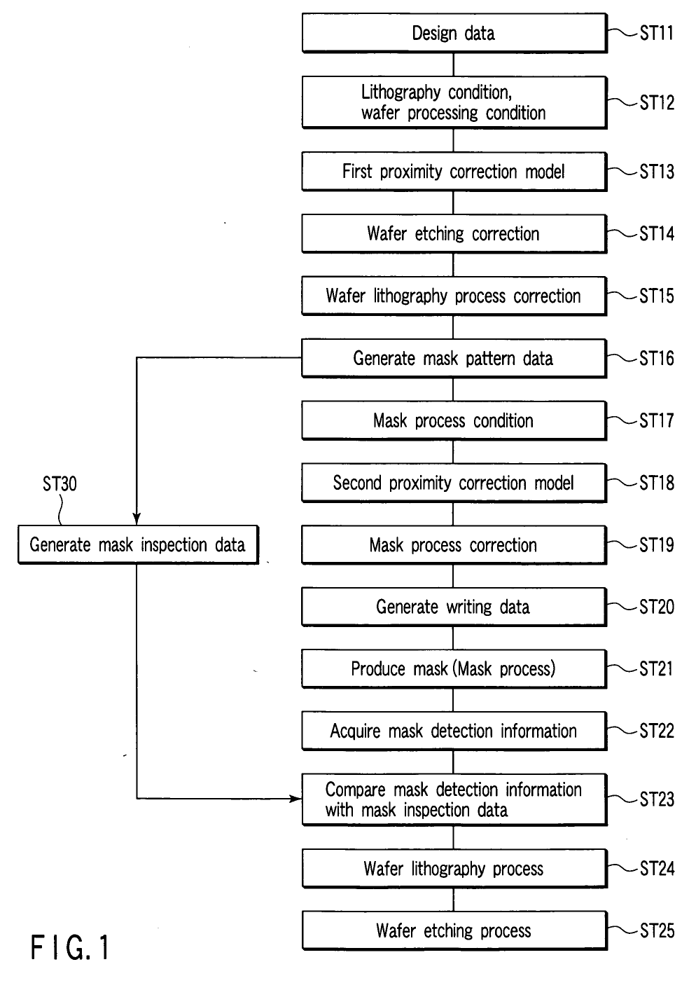

FIG. 1 is a flowchart to explain a method of producing mask inspection data, a method of manufacturing a photo mask and a method of manufacturing a semiconductor device according to an embodiment of the present invention.

First, design data of a semiconductor device is prepared (ST 11). Lithography condition and wafer processing condition are prepared (ST 12). The lithography condition relates to a lithography process for transferring a mask pattern formed on a photo mask on a wafer. The wafer processing condition relates to wafer processing using a pattern transferred on the wafer. In addition, a first proximity correction model is prepared to correct proximity effect relevant to the lithography condition and wafer processing condition (ST 13).

In order to generate data of a resist pattern used as a wafer processing mask, wafer etching corrections are made with respect to design data having a predetermined circuit pattern (ST 14). The foregoing wafer etching corrections are made using a wafer etching correction model (including wafer etching correction rule). The wafer etching correction model is included in the first proximity correction model, and created from wafer etching proximity effect data based on a prepared wafer processing condition. Moreover, the wafer etching correction model is used to correct the dimensional difference between resist pattern dimension and pattern dimension formed on a wafer. The foregoing dimensional difference occurs resulting from PPE (Process Proximity Effect). The correction amount is expressed using a model base (or rule base).

Then, in order to generate data of a pattern to be formed on a photo mask (mask pattern data), lithography process corrections are made with respect to resist pattern data (ST 15). The mask pattern data is dimensional data of a mask pattern to be formed on a photo mask. If the mask pattern is projected onto a resist film via a projection optical system, the dimension of a projected image is variable due to influences such as OPE (Optical proximity Effect) and development. Lithography process corrections are made using a wafer lithography process correction model (including wafer lithography process correction rule). The wafer lithography process correction model is included in the first proximity correction model, and created from wafer lithography process proximity effect data based on prepared lithography conditions (exposure condition, development condition). Moreover, the wafer lithography process correction model is used to correct the dimensional difference between resist pattern dimension and mask pattern dimension. The foregoing dimensional difference occurs resulting from OPE and development. The correction amount is expressed using a model base (or rule base).

In the manner described above, mask pattern data based on the design data and first proximity correction model are generated (ST 16).

A mask process condition for producing a photo mask is prepared (ST 17). In addition, a second proximity correction model for correcting proximity effect relevant to a mask process condition is prepared (ST 18).

Mask process corrections are made with respect to mask pattern data (ST 19). The mask process corrections are made using a mask process correction model (including mask process correction rule). The mask process correction model is included in the second proximity correction model. The mask process correction model is created from mask process proximity effect data based on mask process conditions (exposure condition, development condition and etching condition, etc) when producing a photo mask. Moreover, the mask process correction model is used for correcting the dimensional difference between the dimension on mask pattern data and the dimension of a mask pattern actually formed on a photo mask. The dimensional difference occurs resulting from PPE and the like. The correction amount is expressed using a model base (or rule base). In the manner described above, mask writing data based on the mask pattern data and the second proximity correction model are generated (ST 20).

A photo mask is produced based on mask wiring data and mask process condition (ST 21). Specifically, based on the writing data, a pattern is written on a photo resist formed on a mask blank substrate, and thereafter, the photo resist is developed. A light shield film or half tone film on the mask blank substrate is etched using the resist pattern obtained by development as a mask.

Then, the produced photo mask is inspected. Before the inspection, mask inspection data for inspecting a pattern formed on the photo mask is generated from the mask pattern data created in step ST 16 (ST 30).

The pattern formed on the photo mask is inspected using the mask inspection data created in step ST 30. Specifically, the pattern is inspected in the following manner. The pattern formed on the photo mask is observed using SEM or optical inspection apparatus to produce data for the pattern formed on the photo mask. In other words, the shape of the pattern formed on the photo mask is detected, thereby acquiring mask detection information (ST 22). Thereafter, the acquired mask detection information is compared with mask inspection data, and thereby, it is determined whether or not photo mask defect exists (ST 23). In this case, it may be determined whether or not pattern dimension is suitable. In other words, data (mask detection information) of the pattern formed on the photo mask is compared with mask inspection data to determine whether or not the pattern dimension on the photo mask is within a predetermined allowable range. As described above, the mask inspection data is used as a target dimension, and it is determined whether or not the dimension of the pattern on the photo mask is suitable. By doing so, accurate dimension determination is made. The dimension determination may be made before or after defect determination is made, and may be simultaneously made with the defect determination.

After inspection is made, if a mask pattern is formed within a predetermined error range, the produced photo mask is applied to the actual semiconductor manufacturing process. In other words, a resist pattern is formed on a semiconductor wafer using the photo mask passing the foregoing inspection via a wafer lithography process. Specifically, a pattern formed on the photo mask is transferred onto a resist film formed on a wafer, and further, the resist film is developed (ST 24). Thereafter, the wafer is etched using the formed resist pattern as a mask (ST 25).

As described above, mask inspection data is created from mask pattern data subjected to wafer etching process correction and wafer lithography process correction. The mask inspection data is effective to faithfully represent a pattern formed on the photo mask. Therefore, this serves to reduce an inspection noise resulting from pseudo defect in inspection. Moreover, the target dimension is determined based on the pattern shape of inspection data, and not writing data. By doing so, mask dimension is accurately measured.

According to this embodiment, mask detection information corresponding to the pattern formed on the photo mask is compared with mask inspection data corresponding to mask pattern data having no proximity correction relevant to mask process condition. By doing so, mask inspection accuracy is improved.

The foregoing process is made by one maker, or divided via some makers. If the process is divided, for example, a chip maker (semiconductor device maker) carries out steps ST 11 to ST 16 and ST 30, while a mask maker carries out steps ST 17 to ST 23. Then, the chip maker carries out steps ST 24 and ST 25 using a photo mask produced by the mask maker.

According to another division form, the chip maker carries out steps ST 11 to ST 16 while the mask maker carries out steps ST 17 to ST 23 and ST 30. Then, the chip maker carries out steps ST 24 and ST 25 using a photo mask produced by the mask maker.

In the foregoing process, if proximity effect data relevant to mask process condition is changed, a new mask process correction model is created based on the changed proximity effect data. Then, new mask writing data is generated based on mask pattern data and new mask process correction model.

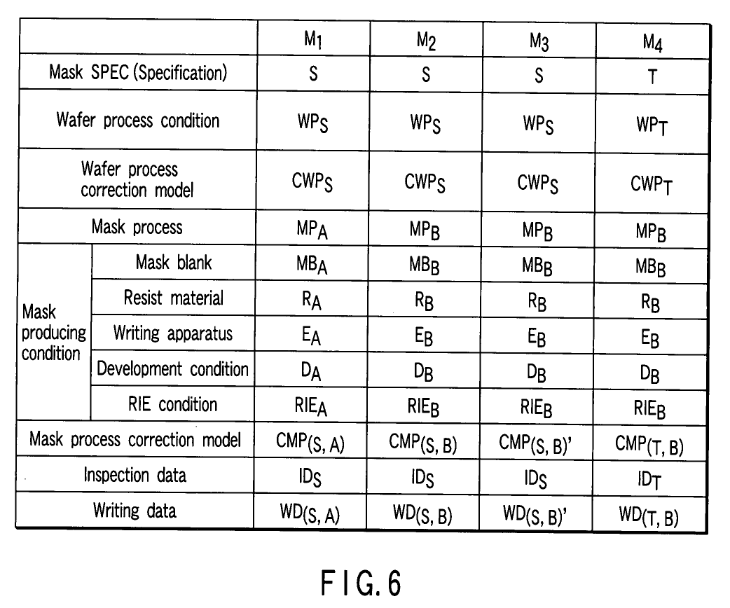

FIG. 6 is a table showing the relationship between mask producing condition, mask process correction model, inspection data and writing data. In FIG. 6, the foregoing wafer etching correction and wafer lithography process correction are included in one wafer process correction model.

A mask producing condition conventionally used to produce a photo mask having a specification S is set as a mask process A. The mask producing condition includes mask blank MB_{A}, resist material R_{A}, writing apparatus E_{A}, development condition D_{A}, and RIE condition RIE_{A}. A mask producing condition of satisfying a specification T more precious than the specification S is set as a mask process B. The mask producing condition includes mask blank MB_{B}, resist material R_{B}, writing apparatus E_{B}, development condition D_{B}, and RIE condition RIE_{B}.

Mask processes MP_{A} and MP_{B} are used to form masks M₁ and M₂ having the mask specification S. In those mask processes MP_{A} and MP_{B}, a mask process correction model (or mask process correction rule) obtained from an OPC curve at mask process only is set as mask process correction model CMP_{(S, A)} and CMP_{(S, B)}.

Based on pattern data subjected to wafer etching correction and wafer lithography correction, writing data created using mask process correction model CMP_{(S,A)} and CMP_{(S, B)} is set as writing data WD_{(S, A)} and WD_{(S, B)}.

Wafer etching process and lithography process condition, that is, wafer process condition is WP_{S} in both photo masks M₁ and M₂. Therefore, mask pattern data before mask process correction for producing photo masks M₁ and M₂ is the same regardless of mask process. Thus, inspection data for inspecting the produced photo masks M₁ and M₂ is the same. In this case, inspection data created from mask pattern data subjected to wafer etching correction and wafer lithography correction is set as inspection data ID_{S}.

Dimension QC management data is variable resulting from long-term process variations although the mask producing process is the same. In this case, a new mask M₃ is formed. If proximity effect data changes, a new mask process correction model CMP_{(S,B)}′ is determined based on the changed proximity effect data. Corrections are made with respect to mask pattern data using the new mask process correction model CMP_{(S,B)}′. By doing so, a mask pattern is formed into a desired shape.

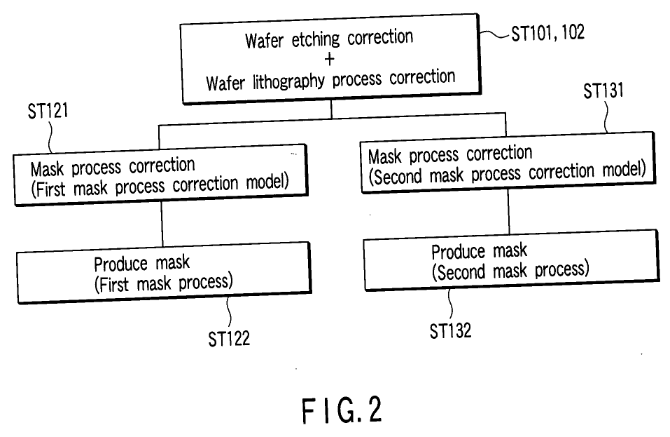

FIG. 2 is a flowchart to explain the procedure of producing masks having the same dimension by only mask process correction using two kinds of mask processes having different mask process conditions. Two kinds of mask writing data are given; however, it is preferable to determine the target dimension value from one kind of mask pattern data subjected to wafer etching correction and wafer lithography correction.

If the mask process MP_{B} is applied to high-precise specification T, mask writing data WD_{(T,B)} is created using a mask process correction model CMP_{(T,B)}. Inspection data is produced from pattern data to which wafer process correction model CWP_{T} is applied.

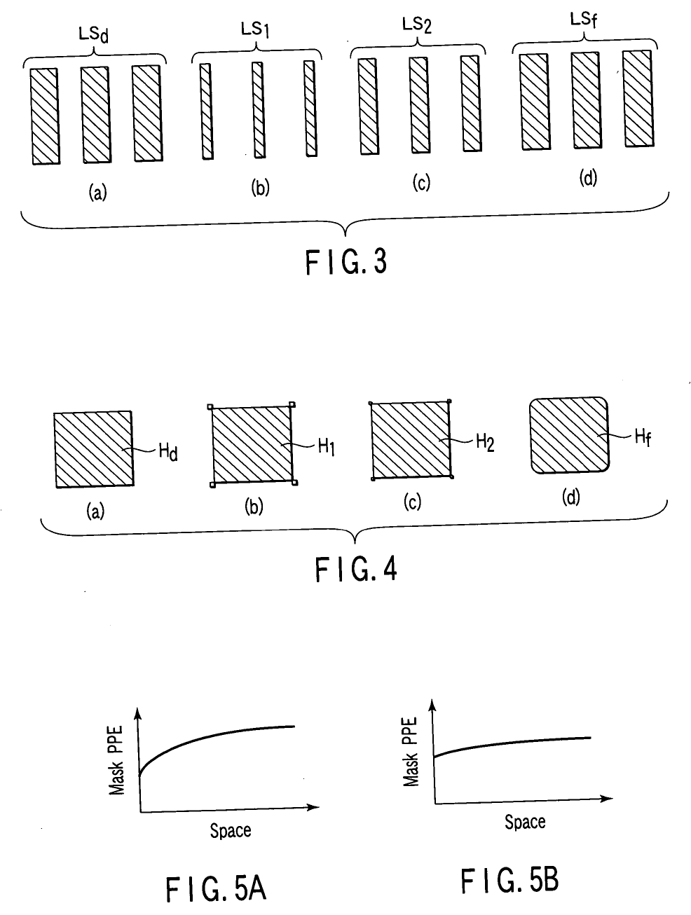

The procedure of producing masks having the same shape by only mask process correction using two kinds of mask processes having different mask process conditions will be explained below with reference to FIG. 2. FIG. 3 and FIG. 4 are views showing mask patterns, writing data patterns and produced patterns.

In order to create mask pattern data, wafer etching process correction and lithography process correction are made with respect to design data (ST 101, ST 102). The mask pattern data includes a line and space pattern LS_{d} shown in FIG. 3(a). Moreover, the mask pattern data includes a hole pattern H_{d} shown in FIG. 4(a).

The case of using a first mask process correction model will be explained below. In order to generate first writing data, mask pattern data is corrected using the first mask process correction model (ST 121). FIG. 5A shows the first mask process correction model. Patterns LS₁ and H₁ after correcting patterns LS_{d} and H_{d} shown in FIG. 3(a) and FIG. 4(a) are shown in FIG. 3(b) and FIG. 4(b), respectively. A mask blank substrate is formed with a pattern via the first mask process based on the first writing data to produce a mask (ST 122).

The case of using a second mask process correction model will be explained below. In order to generate second writing data, mask pattern data is corrected using the second mask process correction model (ST 131). FIG. 5B shows the second mask process correction model. Patterns LS₂ and H₂ after correcting patterns LS_{d} and H_{d} shown in FIG. 3(a) and FIG. 4(a) are shown in FIG. 3(c) and FIG. 4(c), respectively. A mask blank substrate is formed with a pattern via the second mask process based on the second writing data to produce a mask (ST 132).

The shape of patterns LS₁ and H₁ corrected based on the first mask process correction model differs from that of patterns LS₂ and H₂ corrected based on the second mask process correction model. However, patterns LS_{f} and H_{f} formed on a mask each have the same shape, as seen from FIG. 3(d) and FIG. 4(d).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of producing mask inspection data, comprising:
preparing design data of a semiconductor device:
preparing a lithography condition relevant to a lithography process for transferring a mask pattern formed on a photo mask onto a wafer;
preparing a wafer processing condition relevant to wafer processing using a pattern transferred onto the wafer;
preparing a first proximity correction model for correcting proximity effect relevant to the lithography condition and the wafer processing condition;
generating mask pattern data based on the design data and the first proximity correction model; and
generating mask inspection data corresponding to the mask pattern data.

2. The method according to claim 1, wherein the first proximity correction model includes a proximity correction rule for correcting proximity effect relevant to the lithography condition and the wafer processing condition.

3. The method according to claim 1, wherein the first proximity correction model includes a correction model for correcting a dimensional error based on process proximity effect.

4. The method according to claim 1, wherein the first proximity correction model includes a correction model for correcting a dimensional error based on optical proximity effect.

5. A method of manufacturing a photo mask, comprising:
preparing mask pattern data and mask inspection data obtained by the method according to claim 1;
preparing a mask process condition for producing a photo mask;
preparing a second proximity correction model for correcting proximity effect relevant to the mask process condition;
generating mask writing data based on the mask pattern data and the second proximity correction model;
producing a photo mask based on the mask writing data and the mask process condition;
detecting a shape of a pattern formed on the produced photo mask to acquire mask detection information; and
comparing the mask detection information with the mask inspection data to inspect the photo mask.

6. The method according to claim 5, wherein the second proximity correction model is produced using proximity effect data relevant to the mask process condition.

7. The method according to claim 6, further comprising:
generating a new second proximity correction model based on changed proximity effect data if proximity effect data is changed; and
generating new mask writing data based on the mask pattern data and the new second proximity correction model.

8. A method of manufacturing a photo mask, comprising:
preparing mask pattern data for manufacturing a photo mask having a pattern based on design data, the mask pattern data being based on the design data and a first proximity correction model for correcting proximity effect relevant to lithography condition and wafer processing condition, the lithography condition relating to a lithography process for transferring a mask pattern formed on a photo mask onto a wafer, the wafer processing condition relating to wafer processing using a pattern transferred onto the wafer;
generating mask inspection data for inspecting a pattern to be formed on the photo mask based on the mask pattern data;
preparing a mask process condition for producing the photo mask;
preparing a second proximity correction model for correcting proximity effect relevant to the mask process condition;
generating mask writing data based on the mask pattern data and the second proximity correction model;
producing a photo mask based on the mask writing data and the mask process condition;
detecting a shape of a pattern formed on the produced photo mask to acquire mask detection information; and
comparing the mask detection information with the mask inspection data to inspect the photo mask.

9. The method according to claim 8, wherein the first proximity correction model includes a proximity correction rule for correcting proximity effect relevant to the lithography condition and the wafer processing condition.

10. The method according to claim 8, wherein the first proximity correction model includes a correction model for correcting a dimensional error based on process proximity effect.

11. The method according to claim 8, wherein the first proximity correction model includes a correction model for correcting a dimensional error based on optical proximity effect.

12. The method according to claim 8, wherein the second proximity correction model is produced using proximity effect data relevant to the mask process condition.

13. The method according to claim 12, further comprising:
generating a new second proximity correction model based on changed proximity effect data if proximity effect data is changed,; and
generating new mask writing data based on the mask pattern data and the new second proximity correction model.

14. A method of manufacturing a semiconductor device, comprising:
preparing a photo mask manufactured by the method according to claim 5; and
transferring a pattern formed on the photo mask onto a semiconductor wafer.

15. A method of manufacturing a semiconductor device, comprising:
preparing a photo mask manufactured by the method according to claim 8; and
transferring a pattern formed on the photo mask onto a semiconductor wafer.
